(19) United States
(12) Patent Application Publication
(10) Pub. No.: US 2007/0227521 A1
(43) Pub. Date: Oct. 4, 2007

(54) Processing tips and tools using the same

(76) Inventors: Dong Soo Lee, Seoul (KR); Young Se Yoon, Incheon (KR); Yong Ki Shim, Incheon (KR)

Correspondence Address: LEE & MORSE, P.C., 3141 FAIRVIEW PARK DRIVE, SUITE 500, FALLS CHURCH, VA, 22042, US

(21) Appl. No.: 11/600,157

(22) Filed: Nov. 16, 2006

(30) Foreign Application Priority Data
Mar. 17, 2006 (KR) 10-2006-0025059

(51) Int. Cl. B28D 1/02

(52) U.S. Cl. 125/20

(57) ABSTRACT

A processing tip including a first processing part, and a second processing part attached to an upper surface of the first processing part and having a front portion and a rear portion, the front portion having an apex and a first width and the rear portion having a second width, the first width being narrower than the second width.

### BACKGROUND OF THE INVENTION

1. Field of the Invention

The present invention relates to processing tips of cutting tools. In particular, the present invention relates to processing tips and tools employing the same having improved structure capable of minimizing cutting defects.

2. Discussion of the Related Art

In general, diamonds may have very high hardness values, and therefore, they may be employed in cutting tools to facilitate cutting of various materials. In particular, diamonds may be integrated into processing tips of cutting tools as hardness reinforcing components in addition to other materials, such as metal, for the purpose of cutting hard materials, such as granite, marble, brick, firebrick, concrete, asphalt, glass, and so forth.

Processing tips of a cutting tool may be attached to a circumference thereof, such that the processing tips may cut through a material, i.e., a workpiece, upon contact therewith during rotation of the cutting tool. For example, the processing tips may be affixed to the circumference of a rotating disc or plate of a cutting tool, e.g., a saw blade, a gang saw, a chain saw, a frame saw, or any other types of saws, or to the circumference of a punching cylindrical pipe, e.g., a core drill, a processing cup wheel, a polishing disc, and so forth. The cutting tool may be of any size, e.g., anywhere from about 4 inches to about 120 inches in diameter, and the conventional processing tips employed therein may have a corresponding size and a shape of a hexahedron.

However, the shape of the conventional processing tips may form a uniform three-dimensional contact plane with a workpiece. In other words, when a conventional processing tip having, for example, a hexahedral shape contacts a workpiece, one of the hexahedron faces, i.e., a three-dimensional plane, may form a uniform contact with the workpiece, such that the width of the cut in the workpiece over time is constant and uniform. Such a constant and uniform three-dimensional contact between the processing tip and the workpiece may cause noise and vibration, leading to splintering of the workpiece and potential breakage. Additionally, the conventional shape of the processing tips may provide uncontrolled deterioration of the structure thereof, thereby affecting the smoothness of cutting. Accordingly, there remains a need for processing tips of a cutting tool capable of minimizing cutting defects.

### SUMMARY OF THE INVENTION

The present invention is therefore directed to processing tips and a cutting tool employing the same, which substantially overcome one or more of the problems due to the limitations and disadvantages of the related art.

It is therefore a feature of an embodiment of the present invention to provide processing tips having a structure capable of minimizing cutting defects.

It is another feature of an embodiment of the present invention to provide processing tips having a structure capable of providing controlled abrasion thereof.

It is yet another feature of an embodiment of the present invention to provide a cutting tool having processing tips provided with a structure capable of enhancing cutting capabilities.

At least one of the above and other features and advantages of the present invention may be realized by providing a processing tip including a first processing part, and a second processing part attached to an upper surface of the first processing part and having a front portion and a rear portion, the front portion having an apex and a first width and the rear portion having a second width, the first width being narrower than the second width.

The first processing part and the second processing part may include an abrasive material. The front portion may have a higher concentration of abrasive material as compared to the rear portion. In particular, the front portion may include abrasive material in a concentration ranging from about 0.9 carats/cc to about 1.4 carats/cc, and the rear portion may include abrasive material in a concentration ranging from about 0.6 carats/cc to about 0.9 carats/cc.

The abrasive material may include particles of diamond, silica carbide, tungsten carbide, boron nitride, aluminum oxide, or a mixture thereof.

The first processing part may include vertical regions A, B, and C, with region B being formed between region A, and wherein region B may include a lower concentration of abrasive material as compared to region A or region C. The processing tip may further include a bonding portion having a lower concentration of abrasive material as compared to region A, region B, or region C. The ratio of a width of region A to a width of region B to a width of region C may range from about 1:1:1 to about 2:1:2. A height of the first processing part may be longer than a height of the second processing part. Alternatively, the height of the first processing part may be equal to or shorter than the height of the second processing part.

The front portion and the rear portion may form a single triangular shape having a base overlapping with an upper back edge of the first processing part. Further, the apex of the front portion may be positioned at a center line of an upper front edge of the first processing part. Alternatively, the apex of the front portion may be positioned at a center of the upper surface of the first processing part, or the apex of the front portion may be positioned at an upper side edge of the first processing part. The front portion may be curved. Further, a back edge of the rear portion may overlap with a side edge of the first processing part.

A ratio of a length of the front portion to a length of the rear portion may range from about 1:1 to about 3:1.

The processing tip of the present invention may further include at least one incising groove extending in a direction perpendicular to a direction of motion of a cutting tool.

In another aspect of the present invention there is provided a cutting tool, including a shank, a plurality of first processing parts interposed along a circumference of the shank, and a plurality of second processing parts, wherein each second processing part may be attached to an upper surface of the first processing part and having a front portion and a rear portion, the front portion have an apex and a first width and the rear portion having a second width, the first width being narrower than the second width. The shank may be shaped as a disc, a plate, or a tube.

### BRIEF DESCRIPTION OF THE DRAWINGS

The above and other features and advantages of the present invention will become more apparent to those of ordinary skill in the art by describing in detail exemplary embodiments thereof with reference to the attached drawings, in which:

FIG. 1A illustrates a perspective view of a processing tip according to an embodiment of the present invention;

FIG. 1B illustrates a cross-sectional view of the processing tip taken along line A-A′ in FIG. 1A;

FIG. 1C illustrates a cross-sectional view of a cutting tool employing the processing tip illustrated in FIG. 1A and a workpiece cut by the same;

FIG. 1D illustrates a conceptual view of gradual abrasion of a processing tip according to an embodiment of the present invention;

FIG. 1E illustrates a partial front view of a saw-type cutting tool having processing tips according to an embodiment of the present invention;

FIG. 2A illustrates a perspective view of a processing tip according to another embodiment of the present invention;

FIG. 2B illustrates a partial front view of a saw-type cutting tool having processing tips according to the embodiment illustrated in FIG. 2A;

FIG. 3 illustrates a perspective view of a processing tip according to another embodiment of the present invention;

FIG. 4A illustrates a top view of a processing tip according to another embodiment of the present invention;

FIGS. 4B-4C illustrate perspective views of processing tips according to additional embodiments of the present invention;

FIGS. 5A-5B illustrate perspective views of processing tips according to additional embodiments of the present invention;

FIG. 6A illustrates a partial perspective view of processing tips according to another embodiment of the present invention;

FIG. 6B illustrates a partial front view of a saw-type cutting tool having processing tips according to the embodiment illustrated in FIG. 6A;

FIG. 7A illustrates a partial perspective view of processing tips according to another embodiment of the present invention;

FIG. 7B illustrates a partial front view of a saw-type cutting tool having processing tips according to the embodiment illustrated in FIG. 7A;

FIG. 8A illustrates a perspective view of a processing tip according to another embodiment of the present invention;

FIG. 8B illustrates a cross-sectional view of the processing tip taken along line A-A′ in FIG. 8A;

FIG. 9A illustrates a perspective view of a processing tip according to another embodiment of the present invention;

FIG. 9B illustrates a perspective view of a tube-type cutting tool having the processing tip illustrated in FIG. 9A;

FIG. 9C illustrates a cross-sectional view of a workpiece cut by the cutting tool in FIG. 9B; and

FIG. 10 illustrates a perspective view of a tube-type cutting tool having processing tips according to another embodiment of the present invention.

### DETAILED DESCRIPTION OF THE INVENTION

Korean Patent Application No. 10-2006-0025059, filed on Mar. 17, 2006, in the Korean Intellectual Property Office, and entitled: “Processing Tip and. Tools Using the Same,” is incorporated by reference herein in its entirety.

The present invention will now be described more fully hereinafter with reference to the accompanying drawings, in which exemplary embodiments of the invention are illustrated. The invention may, however, be embodied in different forms and should not be construed as limited to the embodiments set forth herein. Rather, these embodiments are provided so that this disclosure will be thorough and complete, and will fully convey the scope of the invention to those skilled in the art.

In the figures, the dimensions of elements and regions may be exaggerated for clarity of illustration. It will also be understood that when a layer or element is referred to as being “on” another layer or substrate, it can be directly on the other layer, element, or substrate, or intervening layers or elements may also be present. Further, it will be understood that when a layer or element is referred to as being “under” another layer or element, it can be directly under, or one or more intervening layers or elements may also be present. In addition, it will also be understood that when a layer or element is referred to as being “between” two layers or elements, it can be the only layer or element between the two layers or elements, or one or more intervening layers or elements may also be present. Like reference numerals refer to like elements throughout.

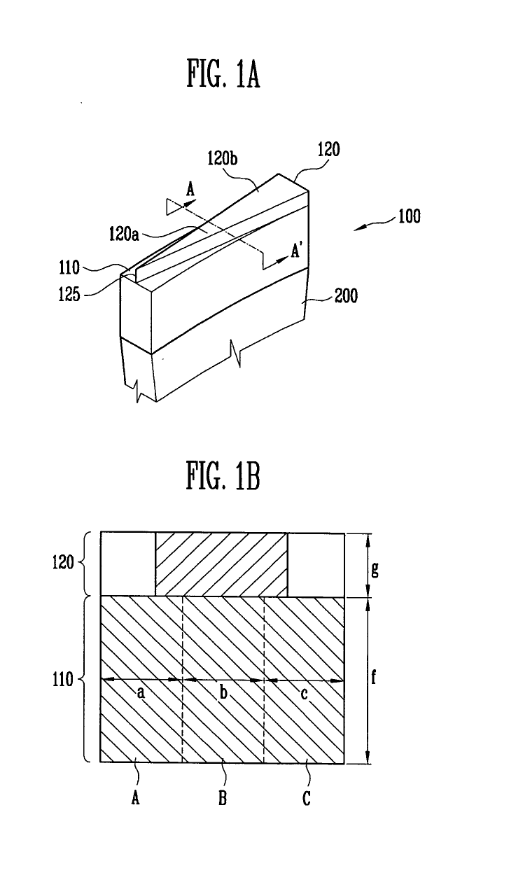

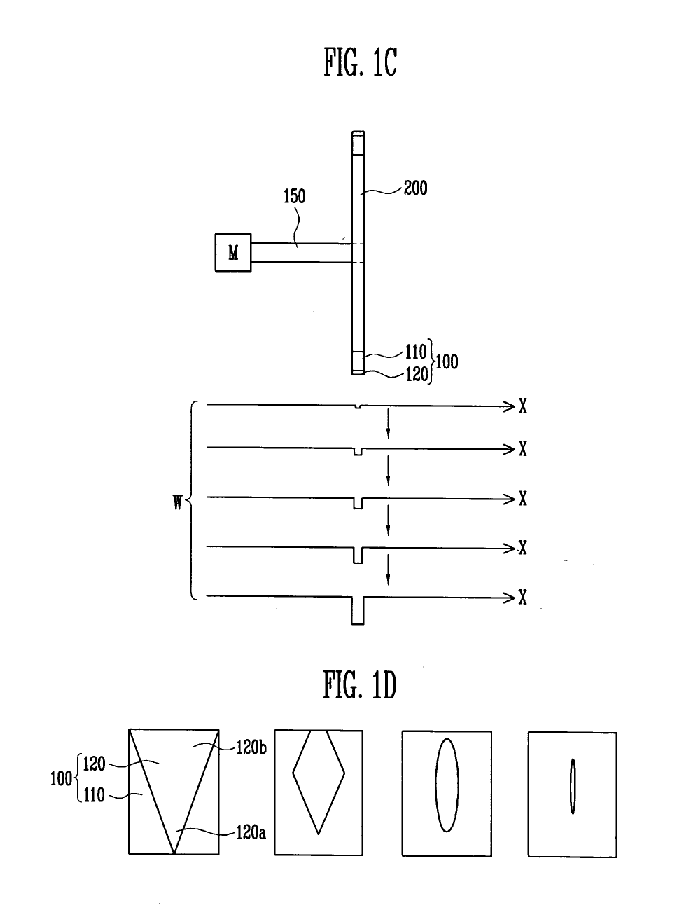

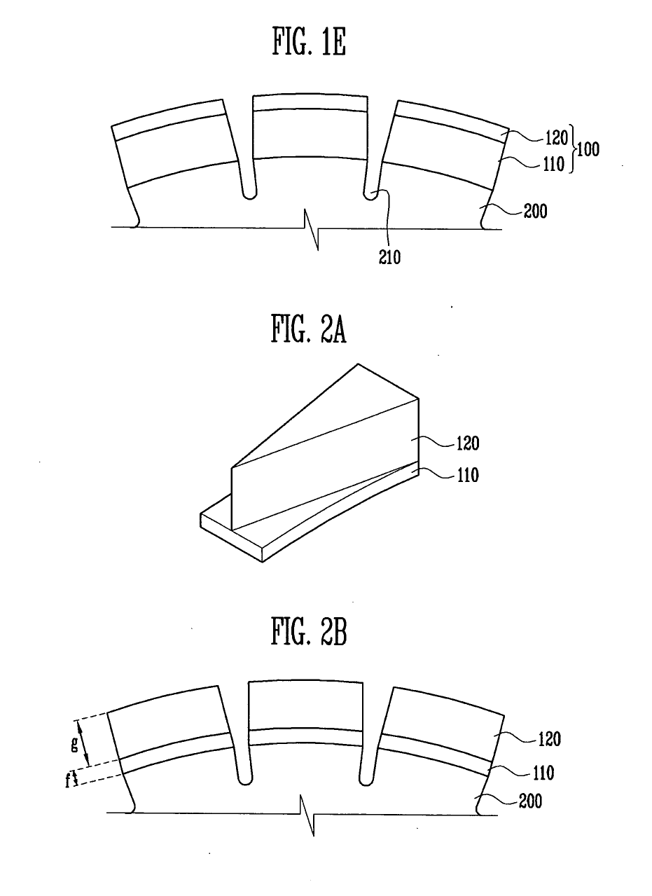

An exemplary embodiment of a processing tip according to the present invention is more fully described below with reference to FIGS. 1A-1E.

As illustrated in FIG. 1A, a processing tip 100 according to an embodiment of the present invention may include a first processing part 110 and a second processing part 120.

The first processing part 110 of the processing tip 100 according to an embodiment of the present invention may be attached to a shank 200 of a cutting tool. The first processing part 110 may be formed in any shape known in the art, e.g., hexahedron, at a predetermined height. The height and shape of the first processing part 110 may depend on the type of materials used for its formation and its intended use.

As illustrated in FIG. 1B, the first processing part 110 may be formed to have a height f, and it may be divided into three vertical regions, i.e., A, B, and C, by an imaginary line drawn perpendicularly to a contact plane between the shank 200 and the first processing part 110. In particular, the first processing part 110 may be divided into two peripheral regions A and C and a central region B formed between regions A and C. As further illustrated in FIG. 1B, regions A, B, and C may have widths a, b and c, respectively. The ratios of a, b, and c may be determined by one of ordinary skill in the art with respect to a type of cutting tool employed and an intended workpiece, i.e., an object intended to be cut Preferably, the ratio of a:b:c may be in the range of from about 1:1:1 to about 2:1:2.

Without intending to be bound by theory, it is believed that the structure of the first processing part 110 described above is advantageous, because during use of the processing tip 100, regions A and C may be employed as guides and region B may be employed as a track, thereby providing initial contact of the workpiece with region B in order to minimize processing tip vibration and enhance its cutting stability.

The first processing part 110 may be formed of a metal composition having abrasive materials integrated therein in order to enhance the hardness of the processing tip 100. In this respect, it should be noted that “hardness,” “hardness properties,” and like terminology with respect to the present invention refer to material property as determined with respect to Brinell Hardness Scale according to an EN ISO 6506-1 test or an ASTM E10 test, or as determined with respect to Rockwell Hardness Scale according to an ISO 6508-1 test or an ASTM E18 test. In this respect, it should also be noted that increased amounts or concentrations of abrasive material in any parts of the processing tip 100 of the present invention may indicate increased hardness.

Preferred metals may include, but are not limited to, cobalt (Co), copper (Cu), tin (Sn), iron (Fe), zinc (Zn), nickel (Ni), and so forth. Preferred abrasive materials may include, but are not limited to, diamond, silicon carbide (SiC), tungsten carbide (WC), boron nitride (BN), aluminum oxide (Al₂O₃), and so forth. The proportions of the metal and abrasive material in the first processing part 110 may vary with respect to the internal structure of the first processing part 110, i.e., regions A, B, and C. For example, it may be preferable to have higher concentrations of abrasive material in regions A and C as compared to region B of the first processing part 110, in order to enhance the hardness of regions A and C.

The second processing part 120 of the processing tip 100 according to an embodiment of the present invention may be attached to an upper surface of the first processing part 110, as can be seen in FIG. 1A, and it may be formed to have a height g, as illustrated in FIG. 1B. The second processing part 120 may be formed to have a front portion 120a, i.e., the portion having a first contact with the workpiece, and a rear portion. 120b, i.e., the portion opposite the front portion 120a.

The front portion 120a may have an apex 125 and a first width, and the rear portion 120b may have a second width, such that the front portion 120a may be narrower than the rear portion 120b, i.e., the first width of the front portion 120a may be narrower than the second width of the rear portion 120b. For example, the second processing part 120 may gradually narrow from the apex 125 towards a back edge of its rear portion 120b to form a triangular shape. However, other shapes are not excluded from the scope of the present invention.

The widths of the front portion 120a and the rear portion 120b may be determined by one of ordinary skill in the art with respect to the type of the cutting tool and the workpiece. In the present embodiment, however, it may be preferable that a back edge of the rear portion 120b of the second processing part may overlap with a back edge of the first processing part 110. For the purpose of ease of description, “edges” may refer to the line segment where faces, i.e., planes, of each of the first and second processing parts 110 and 120 meet. Accordingly, a “front edge” refers to an edge having a first contact with the workpiece, a “back edge” refers to an edge positioned opposite the front edge, and “side edges” refer to the edges between the front and back edges.

The length ratio of the front portion 120a and the rear portion 120b may range from about 1:1 to about 3:1, where the length may be measured in a direction parallel to the side edges of the first processing part 100.

Without intending to be bound by theory, it is believed that the structure of the second processing part 120, i.e., a structure having a narrow front that increases its width towards the rear, may form a point-contact, i.e., one dimensional contact, or a line-contact, i.e., two-dimensional contact, between the processing tip 100 and the workpiece, as opposed to a three-dimensional plane, employed in the conventional art. Minimized initial area of contact between the processing tips 100 and the workpiece may reduce vibrations and splintering of the workpiece, thereby minimizing potential breakage of the workpiece. Further, a point-contact or a line-contact between the processing tip 100 and the workpiece may facilitate formation of an initial cut in the workpiece due to increased pressure relative to reduced area of contact therebetween.

The second processing part 120 may be formed of the same materials as the first processing part 110. In particular, the second processing part 120 may be formed of a metal composition having abrasive materials integrated therein. Preferred metals may include, but are not limited to, cobalt (Co), copper (Cu), tin (Sn), iron (Fe), zinc (Zn), nickel (Ni), and so forth. Preferred abrasive materials may include, but are not limited to, diamond, silicon carbide (SiC), tungsten carbide (WC), boron nitride (BN), aluminum oxide (Al₂O₃), and so forth. The proportions of the metal and abrasive material in the second processing part 120 may be the same or different as compared to the proportions of metal and abrasive materials employed in the first processing part 110. In particular, the proportions of the metal and abrasive material in the second processing part 120 may vary with respect to the internal structure of the second processing part 120, i.e., front and rear portions 120a and 120b, respectively. The proportions of the metal and abrasive material in the second processing part 120 may also vary with respect to the hardness of the workpiece.

For example, it may be preferable to have a higher concentration of abrasive material in the front portion 120a as compared to the rear portion 120b of the second processing part 120, because the front portion 120a may be subjected to higher friction during cutting, thereby requiring enhanced hardness. Accordingly, it may be preferable to gradually lower the concentration of the abrasive material between the apex 125 of the front portion 120a to the back edge of the rear portion 120b. In order to facilitate such a concentration gradient, it may be possible to divide the second processing part 120 into three or more regions.

According to an embodiment of the present invention, it may be preferable to have an abrasive material concentration in the front portion 120a ranging from about 0.9 carats/cc to about 1.4 carats/cc, and an abrasive material concentration in the rear portion 120b ranging from about 0.6 carats/cc to about 0.9 carats/cc. A concentration of abrasive material above about 1.4 carats/cc in the front portion 120a or above about 0.9 carats/cc in the rear portion 120b may cause cutting defects. A concentration of abrasive material below about 0.9 carats/cc in the front portion 120a or above about 0.6 carats/cc in the rear portion 120b may cause unfavorably high deterioration of the processing tip 100.

According to an embodiment of the present invention, the first processing part 110 may be formed such that its length, as measured in a direction parallel to its side edges, may be the same or different as compared to the length of the second processing part 120. For example, the lengths of the second processing part 120 and the first processing part 110 may be the same, i.e., the apex 125 of the front portion 120a of the second processing part 120 may be positioned at a front edge of the first processing part 110, as can be seen in FIG. 1A, while the back edge of the rear portion 120b may overlap with the back edge of the first processing part 110.

Alternatively, the length of the second processing part 120 may be shorter than the length of the first processing part 110. In particular, the second processing part 120 may be formed such that the apex 125 of the front portion 120a of the second processing part 120 may be positioned at a center of an upper surface of the first processing part 110. Alternatively, the second processing part 120 may be formed such that the apex 125 of the front portion 120a of the second processing part 120 may be positioned at any point of either of the side edges of the first processing part 110, e.g., forming a second processing part 120 having a right triangular shape having a height that is shorter than the length of the first processing part 110.

Without intending to be bound by theory, it is believed that the structure of the first and second processing parts 110 and 120, respectively, of the present embodiment may advantageously improve the operation of the processing tip 100, as illustrated in FIG. 1C. In particular, when the shank 200 having a plurality of processing tips 100 rotates around a shaft 150, the plurality of processing tips 100 may form a cut into a workpiece W. In accordance with the present invention, the front portion 120a of the second processing part 120 of each processing tip 100 may form an initial cut having an initial width in the workpiece W. Subsequently, the rear portion 120b of the second processing part 120 and the first processing part 110 may contact the workpiece W upon rotation of the shank 200, thereby expanding the width of the cut. This can be seen in the graphic illustration of FIG. 1C, where the width of the cut shows a relative increase over time, i.e., the width of the cut along the x-axis is increased in each sequential graphical illustration.

The processing tip 100 according to an embodiment of the present invention may be gradually abraded in the process of cutting, as illustrated in FIG. 1D. During the early stages of cutting, the front portion 120a of the second processing part 120 may be abraded first due to its initial contact with the workpiece. Subsequently, the rear portion 120b of the second processing part 120 may be gradually abraded as well. Next, the first processing part 110 may be abraded. In particular, portions of the first processing part 110 having lower concentration of abrasive materials, i.e., region B, may be abraded first, followed by abrasion of regions A and C. Without intending to be bound by theory, it is believed that such controlled abrasion of each specific region of the processing tip 100 may facilitate control over the cutting process and minimize defects resulting from unforeseen abrasion.

As mentioned previously, with respect to FIG. 1C, a plurality of processing tips 100 may be attached to the shank 200. The shank 200 may include a plurality of slots 210 in addition to a plurality of processing tips 100, as illustrated in FIG. 1E. The plurality of slots 210 may have any shape known in the art, and they may be spaced at predetermined intervals along the circumference of the shank 200, such that each processing tip 100 may be attached therebetween. The processing tips 100 may be attached to the shank 200 by any methods known in the art, e.g., welding.

As further illustrated in FIGS. 1A and 1E, the first processing part 110 may be formed such that its height f may be higher than the height g of the second processing part 120. However, the scope of the present invention is not limited thereto, and it should be noted that the heights f and g of the first and second processing parts 110 and 120, respectively, as well as the workpiece, may be taken into consideration when the concentration of abrasive material is determined for the purpose of enhancing the processing tip 100 hardness. In particular, when the height f of the first processing part 110 is decreased and the height g of the second processing part 120 is increased, the concentration of abrasive material in regions A and C of the first processing part 110 may be increased.

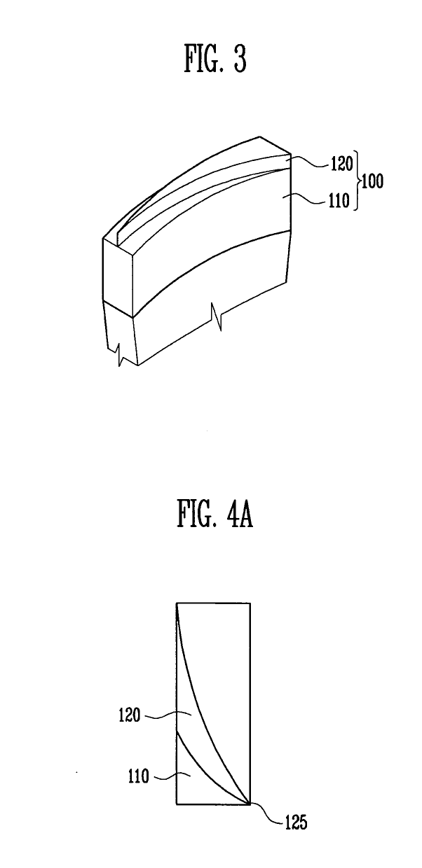

For example, as illustrated in FIGS. 2A-2B, the first processing part 110 may be formed to have a shorter height f as compared to the height g of the second processing part 120. It should further be noted that an embodiment including a first processing part 110 and a second processing part 120 having equal heights is not excluded from the scope of this invention.

The processing tip 100 may be formed to have a curved shape, as illustrated, for example, in FIG. 3. Accordingly, the first and second processing parts 110 and 120 may be formed to have curved shapes as well.

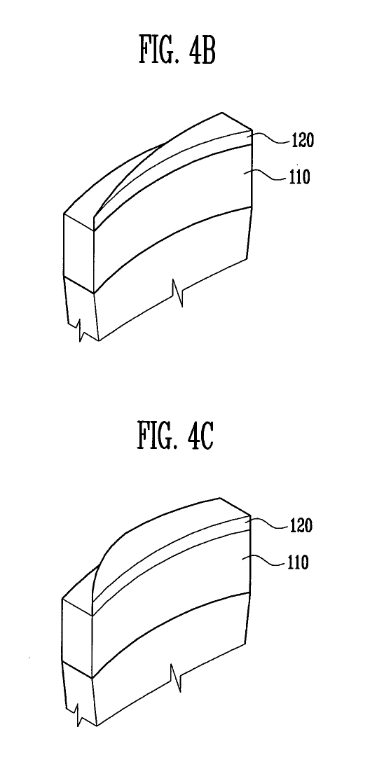

The processing tip 100 of the present invention may be formed such that the second processing part 120 may have various shapes. For example, the second processing part 120 may have a curved shape, while the first processing part 110 may maintain a hexahedral shape. In particular, as illustrated in FIG. 4A, the second processing part 120 may be positioned such that the apex 125 of the front portion 120a may overlap with a front apex of the first processing part 110, and the back edge of the rear portion 120b may be formed to align with a side edge of the first processing part 110.

The second part 120 of the processing tip 100 may also be formed to have curved shapes, as illustrated in FIGS. 4B-4C. For example, the front portion 120a of the second processing part 120 may be positioned to be inclined to one side of the first processing part 110, as opposed to being centered therein, in order to facilitate formation of the second processing part 120.

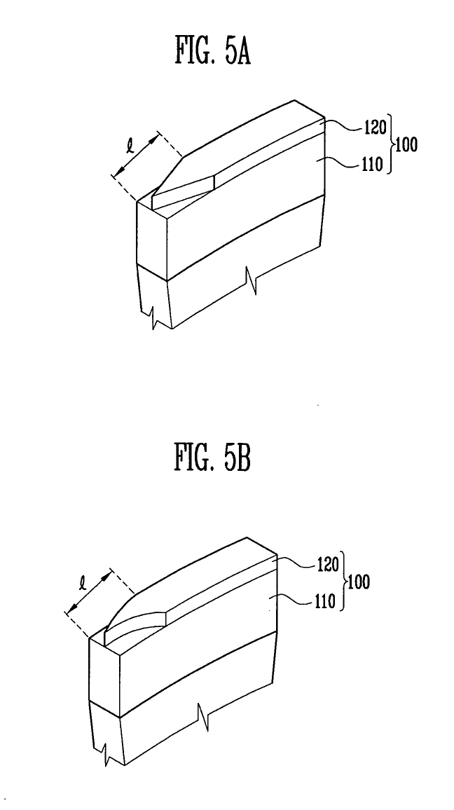

Alternatively, the second processing part 120 may be formed to have a front portion 120a having a triangular or curved shape that widens towards the back edge of the second processing part 120, as illustrated in FIG. 5A-5B. In particular, the front portion 120a may have a length l that may be determined with respect to the type of the workpiece. The rear portion 120b of the second processing part 120 may be formed to have a uniform width that may correspond to the width of the first processing part 110.

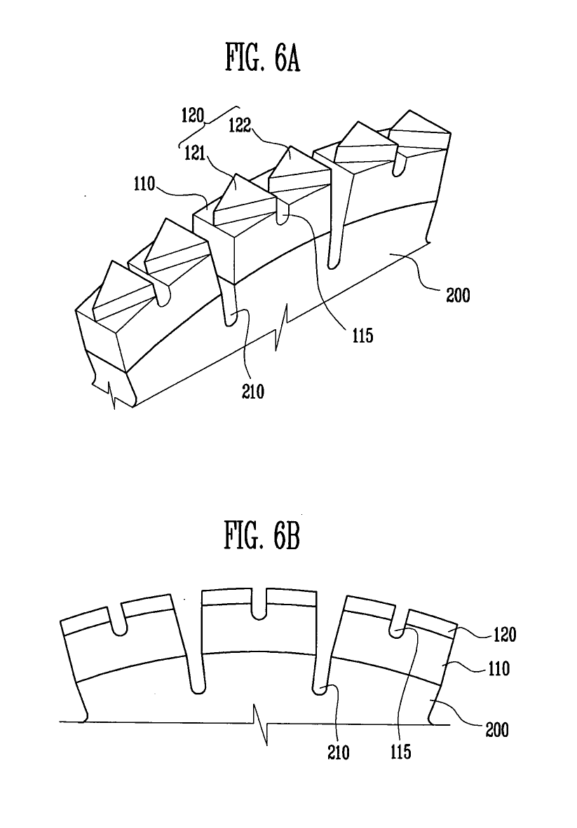

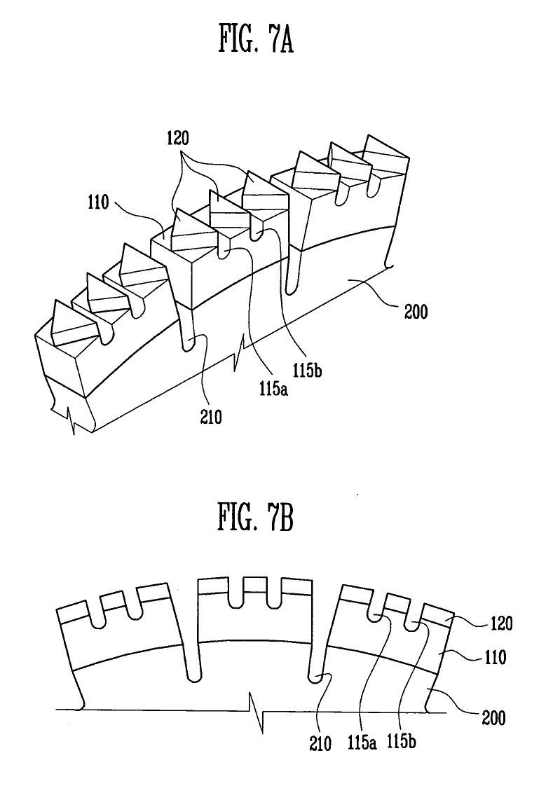

Another embodiment of the present invention is described with reference to FIGS. 6A-7B. As illustrated in FIGS. 6A-7B, the processing tip 100 may additionally include at least one incising groove 115. The incising groove 115 may be formed such that the processing tip 100 may be partially divided into two physically separate regions in a direction perpendicular to a direction of motion of the shank 200, i.e., the incising groove 115 may be formed to have a depth in a direction parallel to a contact plane between the first processing part 110 and the shank 200, and it may be formed to have a length equal to the width of the first processing part 110. For example, the incising groove 115 may be formed such that the second processing part 120 may be divided into two physically separate portions, i.e., first portion 121 and second portion 122, and the first processing part 110 may be partially divided into two separate portions, i.e., only a top portion of the first processing part 110 may be separated, such that a bottom portion of the first processing part 110 may be attached to the shank 200 as a single unit.

Accordingly, the second processing part 120 according to the present embodiment may be formed such that each of its first and second portions 121 and 122 may have a front portion, i.e., the portion having a first contact with the workpiece, that is narrower than a rear portion, i.e., the portion opposite the front portion. For example, each of the first and second portions 121 and 122 of the second processing part 120 may have a triangular shape, as can be seen in FIG. 6A, such that a front portion of each of the first and second portions 121 and 122 may start at an apex and gradually widen its width. The processing tips 100 may also have a plurality of incising grooves 115, e.g., a first incising grove 115a and a second incising groove 115b, as illustrated in FIGS. 7A-7B. Without intending to be bound by theory, it is believed that forming the incising groove 115 may increase the cutting speed of the processing tip 100, while reducing its cutting noise.

As illustrated in FIG. 7B, a shank 200 may include a plurality of slots 210 spaced at predetermined intervals along the circumference thereof and a plurality of processing tips 100 attached therebetween. Each processing tip 100 may include an incising groove 115 formed therein.

The processing tips 100 illustrated in FIGS. 6A-7B may also include at least one meshing projection (not shown) to facilitate alignment of the processing tip 100 with the shank 200, thereby minimizing any cracking generated due to stress around the incising groove 115.

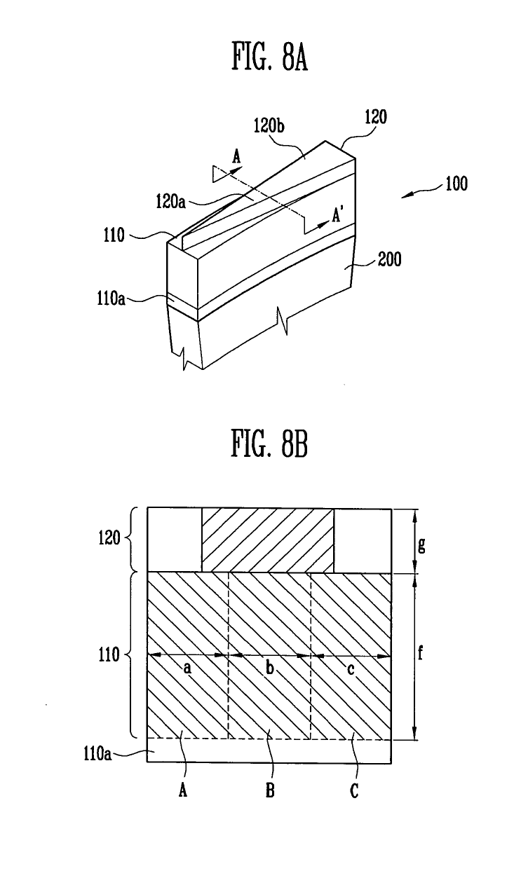

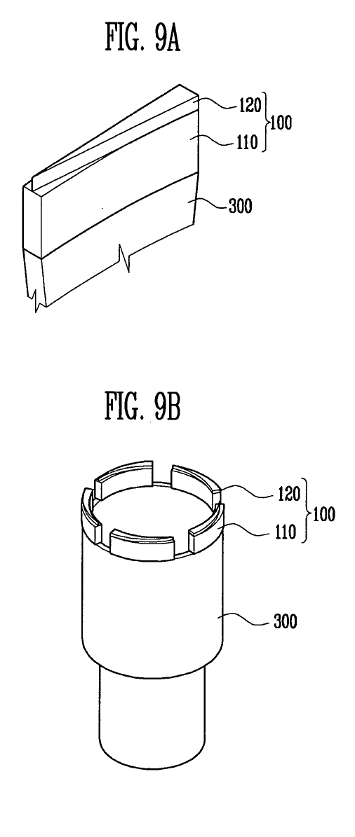

The processing tip 100 of the present invention may also include a bonding part 110a, as illustrated in FIGS. 8A-8B. The bonding part 110a may be formed between the first processing part 110 and an upper surface of the shank 200 in order to replace a base portion (not shown) of the first processing part 110. The bonding part 110a may be employed to attach the processing tip 100 to the shank 200, and it may include a smaller concentration of abrasive material as compared to the concentrations of abrasive material contained in any other portion of the processing tip 100, such that the overall concentration of abrasive material employed in the manufacturing of processing tips 100 may be reduced, thereby reducing economic costs.

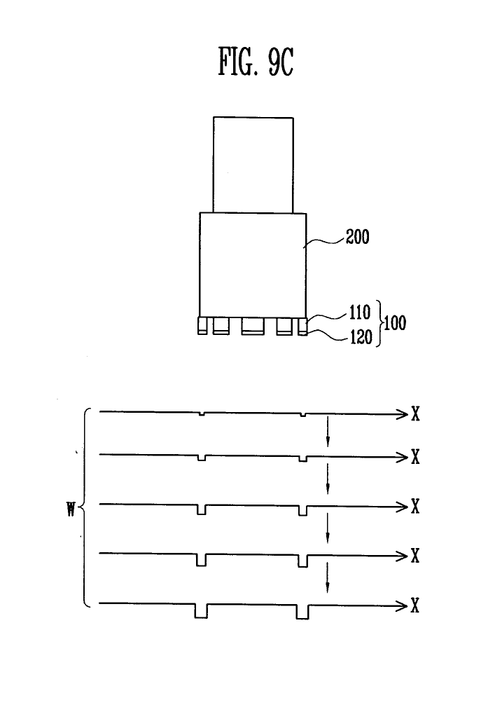

The processing tips 100 of the present invention may also be attached to a drill-type cutting tool, as opposed to a saw-type cutting tool. In particular, as shown in FIGS. 9A-9C, a plurality of processing tips 100 may be attached around a circumference of a shank 300 of a drill-type cutting tool. The processing tips 100 may be attached to the shank 300 by any method known in the art, e.g., welding, and the number of the processing tips 100 employed may depend on the size and specific use of the drill.

It should be noted that when the shank 300 having a plurality of processing tips 100 rotates, the plurality of processing tips 100 may cut into a predetermined location in the a workpiece. In accordance with the present embodiment, the front portion 120a of the second processing part 120 of each processing tip 100 may form an initial cut having an initial width in the workpiece. Subsequently, the rear portion 120b of the second processing part 120 and the first processing part 110 may contact the workpiece upon rotation of the shank 300, thereby expanding the width of the cut. This can be seen in the graphic illustration of FIG. 9C, where the width of the cut shows a relative increase over time, i.e., the width of the cut along the x-axis is increased in each sequential graphical illustration.

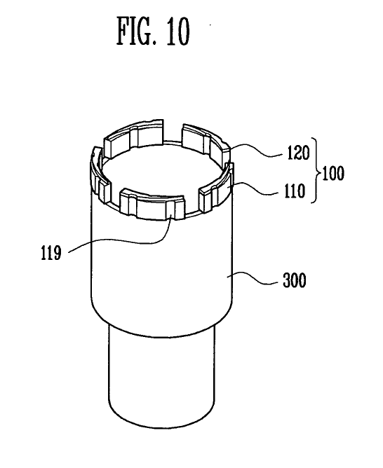

It should be noted that when the processing tips 100 of the present invention are attached to a drill-type cutting tool, they may include at least one groove 119, as illustrated in FIG. 10. The groove 119 may be formed to enhance the cutting ability of the shank 300, while reducing its noise.

It should be noted with respect to the present invention that the processing tips in accordance with the embodiments disclosed herein may be attached to any suitable cutting tools having a movable portion, e.g., a disk, a tube, and so forth, operated by a power transmission apparatus, such as a rotating shaft. In particular, such cutting tools may include a saw blade, a gang saw, a chain saw, a frame saw, a core drill, a processing cup wheel, a polishing disc, and so forth. Attachment of the processing tips to the cutting tools may be done by any method known in the art, e.g., welding method.

It should further be noted that the embodiments disclosed herein may be further modified in terms of the shape of the processing tip 100 and the individual shapes of its first and second processing parts 110 and 120, respectively, the angle of the front portion 120a of the second processing part 120, the position of the incision grooves 115 and grooves 119, the material compositions of the first and second processing parts 110 and 120, respectively, and so forth.

Exemplary embodiments of the present invention have been disclosed herein, and although specific terms are employed, they are used and are to be interpreted in a generic and descriptive sense only and not for purpose of limitation. Accordingly, it will be understood by those of ordinary skill in the art that various changes in form and details may be made without departing from the spirit and scope of the present invention as set forth in the following claims.

What is claimed is:

1. A processing tip of a cutting tool, comprising:
a first processing part; and
a second processing part attached to an upper surface of the first processing part and having a front portion and a rear portion, the front portion having an apex and a first width and the rear portion having a second width, the first width being narrower than the second width.

2. The processing tip as claimed in claim 1, wherein the first processing part and the second processing part include an abrasive material.

3. The processing tip as claimed in claim 2, wherein the front portion includes a higher concentration of abrasive material as compared to the rear portion.

4. The processing tip as claimed in claim 2, wherein the front portion includes abrasive material in a concentration ranging from about 0.9 carats/cc to about 1.4 carats/cc, and the rear portion includes abrasive material in a concentration ranging from about 0.6 carats/cc to about 0.9 carats/cc.

5. The processing tip as claimed in claim 2, wherein the abrasive material includes particles of diamond, silica carbide, tungsten carbide, boron nitride, aluminum oxide, or a mixture thereof.

6. The processing tip as claimed in claim 1, wherein a height of the first processing part is longer than a height of the second processing part.

7. The processing tip as claimed in claim 1, wherein a height of the first processing part is equal to or shorter than a height of the second processing part.

8. The processing tip as claimed in claim 2, wherein the first processing part comprises vertical regions A, B, and C, with region B located between region A and region C and including a lower concentration of abrasive material as compared to region A or region C.

9. The processing tip as claimed in claim 8, further comprising a bonding portion, the bonding portion having a lower concentration of abrasive material as compared to region A, region B, or region C.

10. The processing tip as claimed in claim 8, wherein a ratio of a width of the region A to a width of the region B to a width of the region C may range from about 1:1:1 to about 2:1:2.

11. The processing tip as claimed in claim 1, wherein the front portion and the rear portion form a single triangular shape having a base overlapping with a rear edge of the first processing part.

12. The processing tip as claimed in claim 1, wherein the apex of the front portion is positioned at a front edge of the first processing part.

13. The processing tip as claimed in claim 1, wherein the apex of the front portion is positioned at a center of the upper surface of the first processing part.

14. The processing tip as claimed in claim 1, wherein the apex of the front portion is positioned at a side edge of the first processing part.

15. The processing tip as claimed in claim 1, wherein the front portion is curved.

16. The processing tip as claimed in claim 1, wherein a back edge of the rear portion overlaps with a side edge of the first processing part.

17. The processing tip as claimed in claim 1, wherein a ratio of a length of the front portion to a length of the rear portion ranges from about 1:1 to about 3:1.

18. The processing tip as claimed in claim 2, further comprising at least one incising groove extending in a direction perpendicular to a direction of motion of a cutting tool.

19. A cutting tool, comprising:
a shank;
a plurality of first processing parts interposed along a circumference of the shank; and
a plurality of second processing parts, each second processing part being attached to an upper surface of the first processing part and having a front portion and a rear portion, the front portion having an apex and a first width and the rear portion having a second width, the first width being narrower than the second width.

20. The processing tool as claimed in claim 19, wherein the shank is shaped as a disc, a plate, or a tube.
